(19) United States
(12) Patent Application Publication
(10) Pub. No.: US 2018/0346687 A1
(43) Pub. Date: Dec. 6, 2018

(54) THERMAL INSULATION WINDOW FILM

(71) Applicants: Shigeki Iida, Tokyo (JP); IIDA Research Lab. Co., Ltd., Tokyo (JP)

(72) Inventor: Shigeki Iida, Tokyo (JP)

(21) Appl. No.: 15/718,124

(22) Filed: Sep. 28, 2017

(30) Foreign Application Priority Data
May 31, 2017 (JP) 2017-108067

(51) Int. Cl. C08K 5/12; C08K 3/22; C09J 127/06; C09J 123/08; C09J 131/04; C09J 133/10; C09J 133/08

(52) U.S. Cl. CPC C08K 5/12; C08K 3/2279; C08K 3/22; C09J 127/06; C08K 2003/2258; C09J 131/04; C09J 123/0869; C09J 133/10; C09J 133/08; C09J 123/0853

(57) ABSTRACT

An object is to provide a thermal insulation window film that can be easily attached to a window and does not leave an adhesive on the window when removed. The thermal insulation window film comprises one or more principal-component resins selected from the group consisting of a vinyl chloride resin, an ethylene vinyl acetate copolymer resin, an ethylene methacrylic acid copolymer resin, a polyurethane resin, a polyacrylic resin, and a polyester resin, and a plasticizer, wherein the attached state of the film is maintained via a viscous material resulting from a mixture of the principal-component resin and the plasticizer.

### BACKGROUND OF THE INVENTION

### Field of the Invention

The present invention relates to a thermal insulation window film for attachment to windows and the like.

### Description of the Related Art

Rooms become hot due to sunlight entering through windows. Accordingly, films that reflect or absorb sunlight are attached to windows to prevent an increase of room temperature. This makes it possible to reduce the operation of air conditioners, and saves energy as well. As for thermal insulation window films used for such a purpose, films that are adhered to window glass via a pressure-sensitive adhesive having strong adhesion are in widespread use (for example, Japanese Patent Laid-Open No. 2015-140379 and Japanese Patent Laid-Open No. H8-281860).

### SUMMARY OF THE INVENTION

However, since the pressure-sensitive adhesive has strong adhesion, skilled work is required to attach a film to a window via the pressure-sensitive adhesive. Moreover, there are problems that, for example, replacement work for every 3 to 5 years is troublesome, and the adhesive remains on the glass surface after the film is removed, and stains the glass surface. Accordingly, an object of the present invention is to provide a thermal insulation window film that can be easily attached to a window and does not leave an adhesive on the window when removed.

As a result of having conducted diligent research to achieve the above object, the inventor found that intentionally adding a plasticizer to a principal-component resin in an amount only slightly larger than the amount commonly used makes it possible to attach a film directly to a window without separately providing a bonding adhesive layer. More specifically, the present invention is a thermal insulation window film comprising one or more principal-component resins selected from the group consisting of a vinyl chloride resin, an ethylene vinyl acetate copolymer resin, an ethylene methacrylic acid copolymer resin, a polyurethane resin, a polyacrylic resin, and a polyester resin, and a plasticizer, wherein the attached state of the film is maintained via a viscous material resulting from a mixture of the principal-component resin and the plasticizer.

As described above, the present invention can provide a thermal insulation window film that can be easily attached to a window and does not leave an adhesive on the window when removed.

### DETAILED DESCRIPTION OF THE EMBODIMENT

The thermal insulation window film of the present invention contains one or more principal-component resins selected from the group consisting of a vinyl chloride resin, an ethylene vinyl acetate copolymer resin, an ethylene methacrylic acid copolymer resin, a polyurethane resin, a polyacrylic resin, and a polyester resin.

The thermal insulation window film of the present invention contains a plasticizer. A known plasticizer can be used that is an extremely low-volatile and viscous liquid at room temperature and is chemically inert. Examples of the plasticizer include phthalic acid esters such as dioctyl phthalate, diisononyl phthalate, and dibutyl phthalate, adipic acid esters such as dioctyl adipate and diisononyl adipate, trioctyl trimellitate, carboxylic acid glycol esters, and cresyl phosphate. Preferable is one or more selected from the group consisting of dioctyl phthalate, diisononyl phthalate, dibutyl phthalate, dioctyl adipate, diisononyl adipate, trioctyl trimellitate, carboxylic acid glycol esters, and cresyl phosphate.

Generally, films contain a plasticizer for softening the films. When a plasticizer is excessively contained, a viscous material precipitates (bleeds out) from the films as the time passes. Accordingly, a plasticizer is contained within a range such that the plasticizer can form a solid solution with the principal-component resin so as not to cause bleeding-out. However, in the present invention, the plasticizer is added to the principal-component resin in an amount that exceeds such a range. Thereby, an extremely small amount of a viscous material is precipitated from the film containing the principal-component resin and the plasticizer. Due to this extremely small amount of precipitated viscous material, the film remains attached to the window. That is to say, by intentionally causing the viscous material to bleed out, air is prevented from entering the interface between the glass surface and the film, the interface is kept in a vacuum state, and the film is firmly adhered to the substrate glass at atmospheric pressure. As a rough guide, the plasticizer contained in the thermal insulation window film of the present invention is preferably 20 to 40 parts by weight, more preferably 30 to 40 parts by weight, and even more preferably 30 to 35 parts by weight, based on 100 parts by weight of the principal-component resin. The plasticizer content can be determined in reference to, for example, the plasticizer content in conventional films and the sp values of the principal-component resin and the plasticizer.

Since the viscous material precipitates from the thermal insulation window film of the present invention, the interface between the film and the substrate glass surface is retained in a vacuum state due to the viscous material while the film is attached to the substrate glass surface. And the state of the film attached to the substrate glass is maintained at atmospheric pressure. Accordingly, it is not necessary to provide an adhesive layer on the film body that functions as thermal insulation, and adhesion comparable to that of conventional bonding adhesives is unnecessary. Therefore, the film can be easily attached to a window, and a bonding adhesive does not remain on the window when the film is removed.

When the film is attached to a window with the viscous material resulting from the mixture of the principal-component resin and the plasticizer, it is preferable that the adhesive strength thereof is, for example, 4 N/25 mm or more, and more preferably 8 to 11 N/25 mm, even 2 weeks after attachment. The adhesive strength can be measured in accordance with JIS-A-5759. The thermal insulation window film of the present invention retains a vacuum state due to the viscous material as described above and thus maintains the state of the film attached to the substrate. Accordingly, the film can maintain the attached state not just for 2 weeks or longer, and even for a long term of 3 years or longer.

The thermal insulation window film of the present invention may further contain an infrared absorber. Examples of the infrared absorber include antimony-doped tin oxide, tin oxide-doped indium oxide, tin oxide-doped tungsten oxide, lanthanum boride, rhodium oxide, silver such as silver-sputtered glass nanoflakes, and gold. The infrared absorber is preferably fine particles thereof, and its average particle size is preferably 100 nm or less. The infrared absorber can be 1 to 20 parts by weight based on 100 parts by weight of the principal-component resin.

The thermal insulation window film of the present invention may further contain an ultraviolet absorber. Examples of the ultraviolet absorber include organic ultraviolet absorbers and inorganic ultraviolet absorbers. Examples of organic ultraviolet absorbers include benzophenone, benzotriazole, and triazine ultraviolet absorbers. Examples of benzophenone ultraviolet absorbers include 2,4-dihydroxybenzophenone and 2-hydroxy-4-methoxybenzophenone. Examples of benzotriazole ultraviolet absorbers include 2-(2′-hydroxy-5′-methylphenyl)benzotriazole, 2-(2′-hydroxy-5′-t-buthylphenyl)benzotriazole, 2-(2′-hydroxy-3′,5′-di-t-buthylphenyl)benzotriazole, 2-(2′-hydroxy-3′-t-butyl-5′-methylphenyl)-5-chlorobenzotriazole, 2-(2′-hydroxy-3′,5′-di-t-buthylphenyl)-5-chlorobenzotriazole, 2-(2′-hydroxy-3′,5′-di-t-amylphenyl)benzotriazole, 2-(2′-hydroxy-4′-octoxyphenyl)benzotriazole, and 2-{2′-hydroxy-3′-(3″,4″,5″,6″-tetrahydrophthalimidomethyl)-5′-methylphenyl}benzotriazole. An example of a triazine ultraviolet absorber is 2,4-bis-2-hydroxy-4-butoxyphenyl-6-(2,4-dibutoxyphenyl)-1,3,5-triazine. Examples of inorganic ultraviolet absorbers include zinc oxide, titanium oxide (titania), and cerium oxide.

The organic ultraviolet absorber can be 0.1 to 10 parts by weight based on 100 parts by weight of the principal-component resin. The inorganic ultraviolet absorber can be 5 to 10 parts by weight based on 100 parts by weight of the principal-component resin.

The thermal insulation window film of the present invention can be produced by thermally melting the principal-component resin, optionally adding and dispersing an infrared absorber and an ultraviolet absorber therein to, further, kneading a plasticizer into the principal-component resin to uniformly disperse the plasticizer, and then performing calendar processing or T-die processing. While the thermal insulation window film of the present invention can be used in a multilayer form, it can be used singly without being laminated with another layer. The thickness of the film when used as a single-layer film can be 100 to 500 μm.

The thermal insulation window film of the present invention can be attached to windows. The film can be attached to not only building and vehicle windows but also substrates such as glass that visible light passes through.

### EXAMPLES

### Example 1

Vinyl chloride resin powder (manufactured by Kaneka Corporation, product name S-400) in an amount of 100 g was placed in a 500 cc beaker and thermally melted at 200° C. under a nitrogen atmosphere. Then, 35 g of dioctyl phthalate (manufactured by Sankyo Chemical Co., Ltd., product name DOP) as a liquid plasticizer was added to the solution and, further, 1.5 g of benzophenone powder and 10 g of inorganic nanoparticles of antimony-doped tin oxide were added. The resulting solution was stirred with an ultrasonic homogenizer (manufactured by Microtec Co., Ltd., product name NR-300M) for 1 hour to become uniform, and a molten resin was thus obtained. The molten resin was introduced into a 0.2 mm gap between two fluorine (PTFE) plates through a syringe and cooled to room temperature, and a sample film having a thickness of 200 micrometers of Example 1 was thus obtained. The visible light transmittance, ultraviolet transmittance, solar transmittance, shading coefficient, appearance, residue after removal, and duration of attachment of the resulting sample film were measured or observed as described below. Results are shown in Table 1.

### Example 2

The sample film of Example 2 was obtained in the same manner as in Example 1 except that ethylene-vinyl acetate copolymer resin powder (manufactured by Asahi Kasei Corporation, product name Suntec B770) was used in place of vinyl chloride resin powder, and tin oxide-doped tungsten oxide powder was used in place of inorganic nanoparticles of antimony-doped tin oxide. Measurement and observation were performed on the resulting film in the same manner as in Example 1. Results are shown in Table 1.

### Example 3

Ethylene-methacrylic acid copolymer resin powder (manufactured by DuPont Chemical, product name Elvaloy AC) in an amount of 100 g was placed in a 500 cc beaker and thermally melted at 200° C. under a nitrogen atmosphere. Then, 35 g of diisononyl phthalate (manufactured by Sankyo Chemical Co., Ltd., product name DINP) as a liquid plasticizer was added to the solution and, further, 1.5 g of benzophenone powder and 10 g of tin oxide-doped tungsten oxide powder were added. Afterwards, the sample film of Example 3 was obtained in the same manner as in Example 1. Measurement and observation were performed on the resulting film in the same manner as in Example 1. Results are shown in Table 1.

### Example 4

The sample film of Example 4 was obtained in the same manner as in Example 3 except that polyacrylic resin powder (manufactured by NIPPON SHOKUBAI CO., LTD., product name UW 2816) was used in place of ethylene-methacrylic acid copolymer resin powder. Measurement and observation were performed on the resulting film in the same manner as in Example 1. Results are shown in Table 1.

### Comparative Example 1

The sample film of Comparative Example 1 was obtained in the same manner as in Example 1 except that 10 g, instead of 35 g, of dioctyl phthalate was added. Measurement and observation were performed on the resulting film in the same manner as in Example 1. Results are shown in Table 1.

### Comparative Example 2

An energy-saving window film in which an adhesive was used (manufactured by Lintec Corporation, product name HCN-70) was regarded as the sample film of Comparative Example 2. Also, measurement and observation were performed in the same manner as in Example 1. Results are shown in Table 1.

### Visible Light Transmittance, Ultraviolet Transmittance, Solar Transmittance, Shading Coefficient:

Water was sprayed onto float glass having 15 cm×15 cm×thickness 3 mm, excessive water was removed by a rubber squeegee, the sample films were attached to the float glass, and the optical properties of the films were measured in accordance with JIS A 5759.

### Appearance:

Water was sprayed onto float glass having 15 cm×15 cm×thickness 3 mm, excessive water was removed by a rubber squeegee, the sample films were attached to the float glass, and the appearances of the attached films were visually observed. A finish that did not cause a sense of unpleasantness was evaluated as ∘, and a finish that caused a sense of unpleasantness was evaluated as x.

Residue after Removal:

Water was sprayed onto float glass having 15 cm×15 cm×thickness 3 mm, excessive water was removed by a rubber squeegee, the sample films were attached to the float glass, and the films were dried for 1 hour in an electric furnace at 60° C. After being dried, the films were removed, and the presence and absence of a residue on the glass was visually verified.

### Duration of Attachment:

The sample films were attached to a glass window of a building and left to stand for two weeks. After two weeks, a film remaining attached without change was evaluated as ∘, and a film that did not remain attached was evaluated as x. The mark “-” indicates no measurement. The attached state of the sample films of Examples 1 to 4 did not change even after a long period of time far longer than two weeks.

TABLE 1

| | | | | | Comparative | |
|---|---|---|---|---|---|---|
| | Example | | | | Example | |
| | 1 | 2 | 3 | 4 | 1 | 2 |
| Visible light | 68 | 75 | 78 | 78 | 69 | 75 |
| transmittance (%) | | | | | | |
| Ultraviolet | <1 | <1 | <1 | <1 | <1 | <1 |
| transmittance (%) | | | | | | |
| Solar | 43 | 32 | 35 | 38 | 45 | 38 |
| transmittance (%) | | | | | | |
| Shading coefficient | 0.68 | 0.60 | 0.61 | 0.63 | 0.72 | 0.68 |
| Appearance | ∘ | ∘ | ∘ | ∘ | ∘ | ∘ |
| Residue after removal | none | none | none | none | *1 | present |
| Duration of attachment | ∘ | ∘ | ∘ | ∘ | — | — |

*1: Film fell off the substrate during drying.

What is claimed is:

1. A thermal insulation window film comprising:
one or more principal-component resins selected from the group consisting of a vinyl chloride resin, an ethylene vinyl acetate copolymer resin, an ethylene methacrylic acid copolymer resin, a polyurethane resin, a polyacrylic resin, and a polyester resin; and
a plasticizer, wherein
the attached state of the film is maintained via a viscous material resulting from a mixture of the principal-component resin and the plasticizer.

2. The thermal insulation window film according to claim 1, wherein the plasticizer has a content of 20 to 40 parts by weight based on 100 parts by weight of the principal-component resin.

3. The thermal insulation window film according to claim 1, wherein the plasticizer is one or more selected from the group consisting of dioctyl phthalate, diisononyl phthalate, dibutyl phthalate, dioctyl adipate, diisononyl adipate, trioctyl trimellitate, carboxylic acid glycol esters, and cresyl phosphate.

4. The thermal insulation window film according to claim 1, further comprising one or more infrared absorbers selected from the group consisting of antimony-doped tin oxide, tin oxide-doped indium oxide, tin oxide-doped tungsten oxide, lanthanum boride, rhodium oxide, silver, and gold.

5. The thermal insulation window film according to claim 1, further comprising an organic ultraviolet absorber or an inorganic ultraviolet absorber.
